(19) United States
(12) Patent Application Publication
(10) Pub. No.: US 2006/0257743 A1
(43) Pub. Date: Nov. 16, 2006

(54) Nonaqueous electrolyte cell

(75) Inventors: Junichi Kuratomi, Osaka (JP); Takaaki Iguchi, Osaka (JP); Akinori Ito, Gifu (JP); Ryuji Shiozaki, Tokyo (JP); Kenji Kohno, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: YUASA CORPORATION, Osaka (JP)

(21) Appl. No.: 10/558,887

(22) PCT Filed: Mar. 17, 2004
(86) PCT No.: PCT/JP04/03542

§ 371 Date: Dec. 2, 2005

(30) Foreign Application Priority Data
Jun. 3, 2003 (JP) 2003-157505

(51) Int. Cl. H01M 4/52; H01M 4/50; H01M 10/40; H01M 4/58

(52) U.S. Cl. 429/223; 429/231.3; 429/224; 429/338; 429/231.8

(57) ABSTRACT

An object of the present invention is to provide a nonaqueous electrolyte battery which restrains swelling of the battery during high-temperature storage and is excellent in battery performance after storage.

The invention is characterized by a specific constitution of a nonaqueous electrolyte and a combination thereof with a positive active material having specific crystal structure and composition. Namely, it is characterized by a nonaqueous electrolyte battery containing a positive electrode, a negative electrode, and a nonaqueous electrolyte, wherein the above nonaqueous electrolyte contains at least a cyclic carbonate having a carbon-carbon π bond and the above positive electrode contains a positive active material comprising a composite oxide represented by a composite formula: LiₓMnₐNi_{b}CO_{c}O₂ (wherein 0≦x≦1.1, a+b+c=1, |a-b|<0.05, 0<c<1) and having an α-NaFeO₂-type crystal structure.

### TECHNICAL FIELD

The present invention relates to a nonaqueous electrolyte battery. More specifically, it relates to a nonaqueous electrolyte and a positive active material for use in the nonaqueous electrolyte battery.

### BACKGROUND ART

Since a nonaqueous electrolyte battery exhibits a high energy density, the battery recently attracts attention as a small power source for electronics devices which are increasingly sophisticated and miniaturized and as a large-capacity power source for power storage facilities, electric motorcars, and the like.

In general, a nonaqueous electrolyte battery uses a lithium transition metal composite oxide or the like as a positive electrode; lithium metal, lithium alloy, a carbonaceous material capable of doping/undoping lithium ion, or the like as a negative electrode; and a liquid electrolyte wherein an electrolyte salt is dissolved in a nonaqueous solvent as a nonaqueous electrolyte.

As the above lithium transition metal composite oxide, LiCoO₂, LiNiO₂, LiMnO₂, LiMn₂O₄, and the like are known. Of these, LiCoO₂ having an α-NaFeO₂ type crystal structure is widely used since it has a high energy density. Lately, lithium manganese nickel cobalt composite oxides having an a-NaFeO₂ type crystal structure have been reported in the following Non-Patent Documents 1 to 3. According to these reports, it is considered that Mn, Ni, and Co occupying the 6b site of the layer structure represented by a space group R3-m are regularly arranged and a layer formed by the 6b side becomes strong in the case that a supperlattice structure is formed, whereby repulsion between oxygens caused by lithium extraction is reduced (With respect to expressions of space groups, the expression should originally bear a bar (lateral line) affixed over the numeral “3” but, in this description, the expression “R3-m” is used for convenience).

As the above nonaqueous electrolyte, one wherein an electrolyte salt is dissolved in a nonaqueous solvent has been generally employed. As the above electrolyte salt, lithium phosphohexafluoride (LiPF₆) has been widely used. Moreover, as the above nonaqueous solvent, a cyclic carbonate ester such as ethylene carbonate or propylene carbonate and a cyclic carboxylate ester such as γ-butyrolactone, or the like is widely known as a solvent having a high dielectric constant.

Since the above nonaqueous solvent generally has a higher oxidative decomposition potential, it is stably present at the positive electrode. However, since it has relatively higher reductive decomposition potential, it sometimes decomposes at the negative electrode. As means for preventing the decomposition, technologies to add vinylene carbonate or a derivative thereof which is reduced at a potential about 1 V higher than the potential of metallic lithium into the above nonaqueous electrolyte are disclosed in the following Patent Documents 1 to 4. It is understood that a coated film composed of decomposition products of vinylene carbonate is formed on the surface of the negative electrode by adding vinylene carbonate into the nonaqueous electrolyte and thus the decomposition of the nonaqueous electrolyte is prevented.

Non-Patent Document 1: Z. Lu. D. D. Macneil, J. R. Dahn, “Electrochemical and Solid-State Letters”, (USA), 2001, Vol. 4, No. 12, p. A200-A203.

Non-Patent Document 2: Y. Koyama, I. Tanaka, H. Adachi, Y. Makimura, N. Yabuuchi, T. Ohzuku, “42th Dennchi Tohronkai Preprints”, (Japan), 2001, p. 50-51.

Non-Patent Document 3: Y. Makimura, N. Yabuuchi, T. Ohzuku, Y. Koyama, “42th Dennchi Tohronkai Preprints”, (Japan), 2001, p. 52-53.

Patent Document 1: JP-A-8-45545

Patent Document 2: JP-A-11-67266

Patent Document 3: JP-A-2001-85059

Patent Document 4: JP-A-2001-126763

### DISCLOSURE OF THE INVENTION

The conventional nonaqueous electrolyte batteries have problems that the batteries swell when they are left standing under a high-temperature environment for a long period of time or recovery of dischargeable capacity is insufficient even when they are charged.

The present invention is carried out in consideration of the above problems and an object of the invention is to provide a nonaqueous electrolyte battery which restrains swelling of the battery during high-temperature storage and is excellent in battery performance after storage.

As a result of the extensive studies for solving the above problems, the present inventors have found that the above problems are solved by a specific constitution of a nonaqueous electrolyte and a combination thereof with a positive active material having specific crystal structure and composition. The constitution of the invention is as follows. However, the action mechanism includes a presumption and the “success and failure” of the action mechanism does not limit the invention.

The invention lies on a nonaqueous electrolyte battery comprising a positive electrode, a negative electrode, and a nonaqueous electrolyte, wherein the above nonaqueous electrolyte contains at least a cyclic carbonate having a carbon-carbon π bond and the above positive electrode contains a positive active material comprising a composite oxide represented by a composite formula: LiₓMnₐNi_{b}CO_{c}O₂ (wherein 0≦x≦1, a+b+c=1, |a-b|<0.05, 0<c<1) and having an α-NaFeO₂-type crystal structure.

Moreover, the invention lies on a honaqueous electrolyte battery comprising a positive electrode, a negative electrode, and a nonaqueous electrolyte, wherein the above positive electrode contains a positive active material comprising a composite oxide represented by a composite formula: LiₓMnₐNi_{b}CO_{c}O₂ (wherein 0≦x≦1, a+b+c=1, |a-b|<0.05, 0<c<1) and having an α-NaFeO₂-type crystal structure and the battery is fabricated using a nonaqueous electrolyte containing at least a cyclic carbonate having a carbon-carbon π bond.

By fabricating a nonaqueous electrolyte battery using a nonaqueous electrolyte containing at least a cyclic carbonate having a carbon-carbon π bond, a lithium ion-permeable protective coated film is formed on the surface of the negative electrode and hence the decomposition of the other nonaqueous solvents can be restrained, so that gas generation which is a cause of the swelling can be restrained and battery performance can be improved.

The above cyclic carbonate having a carbon-carbon π bond is preferably one or more selected from the group consisting of vinylene carbonate, styrene carbonate, catechol carbonate, vinylethylene carbonate, 1-phenylvinylene carbonate, and 1,2-diphenylvinylene carbonate.

By using one selected from the above group as the cyclic carbonate having a carbon-carbon π bond contained in the nonaqueous electrolyte, a lithium ion-permeable protective film formed on the surface of the negative electrode during first charging becomes more dense and excellent in lithium ion permeability. Therefore, the decomposition of the other nonaqueous solvents constituting the nonaqueous electrolyte can be more effectively restrained, charge and discharge after second cycle can be sufficiently effected, and thus a charge and discharge efficiency can be improved. In this connection, first charge means charge conducted in the first place after the battery is constructed.

As a result of extensive studies on the positive active material for use in the positive electrode in the nonaqueous electrolyte battery using a nonaqueous electrolyte which contains at least a cyclic carbonate having a carbon-carbon π bond, the inventors have surprisingly found that particularly remarkable effects that swelling of the battery during storage at a high temperature is restrained and battery performance after storage is excellent can be exhibited by using specific crystal structure and chemical composition of the positive active material to be used in the positive electrode.

Namely, in the nonaqueous electrolyte battery wherein conventional LiCoO₂ is used as the positive active material, even when a nonaqueous electrolyte containing vinylene carbonate which is one of cyclic carbonates having a carbon-carbon π bond is used, large swelling of the battery and decrease in capacity are observed when the battery has been left in an end-of-charge state under a high temperature environment for a long period of time. On the other hand, in the nonaqueous electrolyte battery using a nonaqueous electrolyte similarly containing vinylene carbonate, when a lithium manganese nickel cobalt composite oxide having an α-NaFeO₂-type crystal structure and having a specific chemical composition is used as the positive active material, it has been found that swelling of the battery and decrease in capacity are remarkably restrained even when the battery has been left in an end-of-charge state under a high temperature environment for a long period of time. Furthermore, the restraining effect of swelling of the battery and decrease in capacity is more remarkably exhibited by further specifying the compositional range of the above lithium manganese nickel cobalt composite oxide having an α-NaFeO₂-type crystal structure.

The action and effect is not necessarily clear at present. The oxidative decomposition potential of the materials constituting the nonaqueous electrolyte is about 5.5V (v.s. Li/Li⁺) for ethylene carbonate and ethyl methyl carbonate, which are solvents having a high dielectric constant, but is about 4.5V (v.s. Li/Li⁺) for vinylene carbonate. On the other hand, the working potential of the above LiCoO₂ is hardly different from the working potential of the lithium manganese nickel cobalt composite oxide having an α-NaFeO₂-type crystal structure used for the investigation by the inventors. Accordingly, it is hardly considered that only the potential is relevant. According to the findings of the inventors to date, it is strongly suggested that there is a difference between kinds of the reactions of part of the materials constituting the nonaqueous electrolyte with the material of the positive active material and the materials relevant to the reactions act on the negative electrode side to influence the state of the coated film on the surface of the negative electrode.

Moreover, the negative electrode for use in the nonaqueous electrolyte battery of the invention preferably contains a graphite. Since a graphite has working potential very close to the potential of metallic lithium (−3.045V v.s. NHE in the case of an aqueous solution) and irreversible capacity in charge/discharge can be diminished, a nonaqueous electrolyte battery having a high working voltage and a high energy density can be obtained.

Furthermore, the invention lies on a nonaqueous electrolyte battery wherein the above nonaqueous electrolyte uses a mixture of an inorganic lithium salt and an organic lithium salt having a perfluoroalkyl group. According to such a constitution, high-temperature storage performance can be improved.

### BRIEF DESCRIPTION OF THE DRAWINGS

FIG. 1 is a sectional view of the nonaqueous electrolyte battery according to Example.

FIG. 2 is a graph showing a high-temperature storage performance (battery thickness increase ratio) of the battery according to Example.

FIG. 3 is a graph showing a high-temperature storage performance (0.2It recovered capacity retention ratio) of the battery according to Example.

FIG. 4 is a graph showing a high-temperature storage performance (1.0It recovered capacity retention ratio) of the battery according to Example.

FIG. 5 is a graph showing a high-temperature storage performance (2It high-rate discharge characteristic) of the battery according to Example.

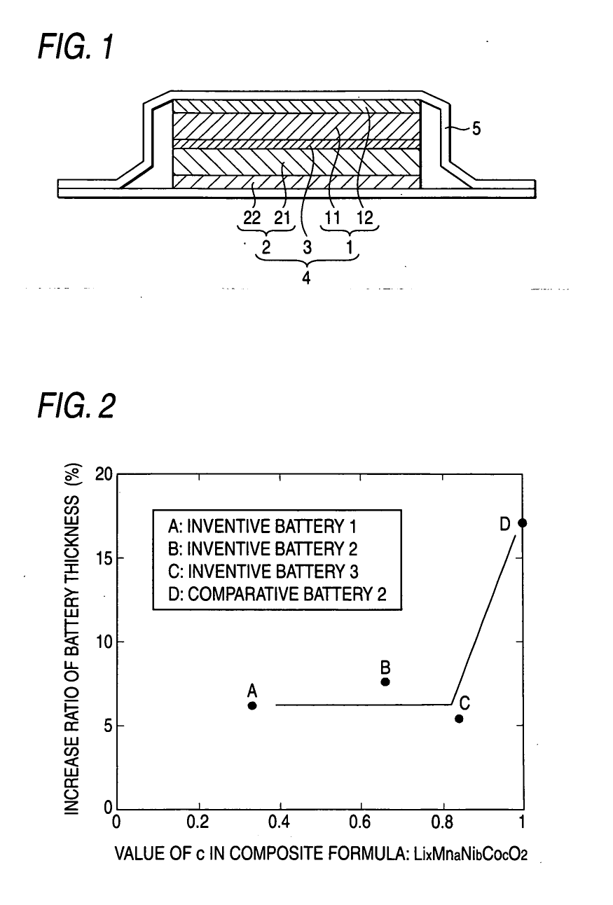

With regard to the numerals in FIG. 1, 1 is a positive electrode, 11 is a positive composite, 12 is a positive collector, 2 is a negative electrode, 21 is a negative composite, 22 is a negative collector, 3 is a separator, 4 is an electrode group, and 5 is a metal-resin laminate film.

### BEST MODE FOR CARRYING OUT THE INVENTION

The following will describe embodiments of the invention in detail but the invention is not limited to these descriptions.

In the invention, as the nonaqueous solvents constituting the nonaqueous electrolyte, nonaqueous solvents for use in nonaqueous electrolytes for nonaqueous electrolyte batteries can be employed. For example, cyclic carbonates (propylene carbonate, ethylene carbonate, butylene carbonate, chloroethylene carbonate, etc.), cyclic esters (γ-butyrolactone, γ-valerolactone, propiolactone, etc.), linear carbonates (dimethyl carbonate, diethyl carbonate, ethyl methyl carbonate, diphenyl carbonate, etc.), linear esters (methyl acetate, methyl butyrate, etc.), tetrahydrofuran or derivatives thereof, ethers(1,3-dioxane, dimethoxyethane, diethoxyethane, methoxyethoxyethane, methyldiglyme, etc.), nitrites (acetonitrile, benzonitrile, etc.) can be mentioned which may be used solely or as a mixture of two or more thereof, but the solvents should not be construed as being limited to these examples. Moreover, there can be used phosphate esters which are nonflamable solvents and which may be generally used through addition to nonaqueous electrolytes. For example, trimethyl phosphate, triethyl phosphate, ethyl dimethyl phosphate, diethyl methyl phosphate, tripropyl phosphate, tributyl phosphate, tri(trifluoromethyl)phosphate, tri(trifluoroethyl)phosphate, tri(triperfluoroethyl)phosphate, and the like can be mentioned, but the solvents should not be construed as being limited to these examples. They may be used solely or as a mixture of two or more thereof.

In order to exhibit the effects of the invention effectively, it is preferable that the nonaqueous solvent constituting the nonaqueous electrolyte contains one or more cyclic organic compounds having no carbon-carbon π bond. Thereby, even in the case that the amount of the above cyclic carbonate having a carbon-carbon π bond to be added is small, the lithium ion-permeable protective coated film to be formed on the surface of the negative electrode is particularly dense and excellent in lithium ion permeability, so that the decomposition of the nonaqueous solvent (exclusive of the above cyclic carbonate having a carbon-carbon π bond) constituting the nonaqueous electrolyte can be more effectively restrained.

The amount of the above carbonate having a carbon-carbon π bond in the ring and the cyclic organic compound having no carbon-carbon π bond in total in the whole nonaqueous electrolyte is preferably from 0.01% by weight to 20% by weight, more preferably from 0.10% by weight to 10% by weight based on the total weight of the nonaqueous electrolyte. By setting the amount to 0.01% by weight or more based on the total weight of the nonaqueous electrolyte, the decomposition of the nonaqueous solvents constituting the nonaqueous electrolyte during first charge can be almost completely restrained and charging can be more surely conducted. Moreover, by setting the amount to 20% by weight or less based on the total weight of the nonaqueous electrolyte, the decomposition of the cyclic carbonate having a carbon-carbon π bond, the cyclic organic compound having no carbon-carbon π bond as a nonaqueous solvent, and the like can be minimized, so that a nonaqueous electrolyte battery having a sufficient battery performance can be obtained. In this connection, the ratio of the above cyclic carbonate having a carbon-carbon π bond to the above cyclic organic compound having no carbon-carbon π bond contained therein can be optionally selected.

In particular, the above cyclic organic compound having no carbon-carbon π bond is preferably selected from cyclic carbonates having a high dielectric constant and having no carbon-carbon π bond and especially is preferably one or more selected from the group consisting of ethylene carbonate, propylene carbonate, and butylene carbonate.

As the electrolyte salt constituting the nonaqueous electrolyte, an electrolyte salt stable in a wide potential region generally used in the nonaqueous electrolyte battery can be suitably employed. For example, as a lithium salt, LiBF₄, LiPF₆, LiClO₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, and the like may be mentioned but the salt should not be construed as being limited to these examples. They may be used solely or as a mixture of two or more thereof. In this connection, when the inorganic lithium salt such as LiPF₆ or LiBF₄ and the organic lithium salt having a perfluoroalkyl group, such as LiN(CF₃SO₂)₂ or LiN(C₂F₅SO₂)₂ are used as a mixture, not only the viscosity of the nonaqueous electrolyte can be maintained low but also there arises an effect of improving a high-temperature storage performance, so that the case is more preferable.

The concentration of the electrolyte salt in the nonaqueous electrolyte is preferably from 0.1 mol/L to 5 mol/L, more preferably 1 mol/L to 2.5 mol/L in order to surely obtain a nonaqueous electrolyte battery having high battery characteristics.

In the Li—Mn—Ni—Co system composite oxide having an α-NaFeO₂ type crystal structure used as the positive active material, the composition ratio of Mn to Ni is preferably about 1:1. The above composite oxide is generally prepared by thermal treatment of a precursor but when the amount of Mn is too large relative to the amount of Ni, Li₂MnO₃ and the like are apt to form during the process of the thermal treatment and thus homogeneity of the composite oxide to be formed may be lost.

For example, When Li₂MnO₃ co-exists, it has a function to improve reversibility of insertion/extraction of lithium ions toward the above Li—Mn—Ni—Co system composite oxide having an α-NaFeO₂ type crystal structure but, as is surmised from the fact that Li₂MnO₃ alone is an electrochemically inactive substance at a potential of around 4V, it may cause decrease in capacity when exists in a large amount. To the contrary, when the amount of Ni is large as compared with the amount of Mn, the Li—Mn—Ni—Co system composite oxide to be formed has a homogeneous crystal structure when measured by X-ray diffraction but there is a possibility that thermal stability during charge decreases owing to the increased amount of Ni in the 6b site, so that the case is not preferable. Therefore, in the composite formula: LiₓMnₐNi_{b}Co_{c}O₂, it is necessary to satisfy the requirement of |a-b|<0.05.

Incidentally, the elements of the 6b site, such as Mn, Ni, and Co, in the composite oxide may be replaced by a different element M. Namely, the different element M is preferably one or more elements of the Groups 1 to 16 excluding Mn, Ni, Co, Li and O, which are preferably elements replaceable with the above elements of the 6b site. For example, there may be mentioned Be, B, V, C, Si, P, Sc, Cu, Zn, Ga, Ge, As, Se, Sr, Mo, Pd, Ag, Cd, In, Sn, Sb, Te, Ba, Ta, W, Pb, Bi, Fe, Cr, Ni, Ti, Zr, Nb, Y, Al, Na, K, Mg, Ca, Cs, La, Ce, Nd, Sm, Eu, Tb, and the like, but the elements should not be construed as being limited to these examples. They may be used solely or as a mixture of two or more thereof. Of these, the use of any of V, Al, Mg, Cr, Ti, Cu, and Zn is further preferable since a particularly remarkable effect is obtained in high-rate discharge performance. However, when the amount of the different element M is too large, there is a possibility that an electrochemical capacity as a positive active material may decrease, so that it is preferable that the oxide is represented by the composite formula: LiₓMnₐNi_{b}Co_{c}M_{d}O₂ and satisfies the requirements of a+b+c+d=1 and the value of d is 0.1 or less.

As a method for replacing part of the above 6b site by a different element, in the case that the composite oxide is prepared by the method wherein a precursor is thermally treated, there may be used a method wherein the different element is added beforehand to the precursor. Moreover, there may be used a method wherein replacement by the different element is conducted by an ion-exchange method or the like after preparation of the composite oxide. However, the method should not be construed as being limited to these methods.

With regard to the Li—Mn—Ni—Co system composite oxide according to the invention, as mentioned previously, it is important that the elements in the 6b site are homogeneously mixed and diffused but it is more important to restrain the reaction that manganese, nickel, or cobalt reacts with lithium to form another form of composite oxide during the preparation process of the composite oxide. In particular, manganese and nickel exhibit a low solid-phase diffusion rate during the thermal treatment and when a compound such as Li₂MnO₃ (space group C2-m) is formed, it does not undergo a phase change into LiMO₂ type oxide (space group R3-m), so that care should be particularly paid.

In order to solve the above problem, the composite oxide can be suitably prepared by preparing a precursor having a homogeneous transition metal element species, mixing a Li compound therewith, and subjecting the mixture to a solid-phase reaction through thermal treatment.

The above precursor may be easily prepared when obtained as a composite hydroxide or a composite carbonate. Of these, when it is obtained as a composite hydroxide, the case is more preferable because of easy preparation and easy control of its secondary particle form.

The following will describe a preferred form of the above precursor usable for preparation of the Li—Mn—Ni—Co system composite oxide according to the invention and a preparation method thereof.

The above precursor is preferably a compound wherein Mn atoms and, if necessary, Co atoms are homogeneously arranged with Ni atoms at the Ni sites in a Ni(OH)₂ type crystal structure. The valency of the Mn atom constituting the precursor crystal is preferably divalent. When the precursor crystal mainly contains divalent Mn, the formation of Li₂MnO₃ as an impurity phase can be diminished in a product after thermal treatment. This is because the Li₂MnO₃ is an electrochemically inactive substance at around 4V and has a function of stabilizing the crystal structure of the composite oxide but causes decrease in capacity and hence it is preferable to control the content of Li₂MnO₃ contained in the composite oxide (positive active material) so that the content does not becomes too much.

The method of preparing the above precursor is not particularly limited as long as the method satisfies the above requirements. There may be adopted “a coprecipitation process” wherein an acidic aqueous solution containing at least Ni and Mn is added dropwise to an aqueous alkali solution such as an aqueous sodium hydroxide solution as a reaction solution to generate a precipitate. The precursor is obtained by drying the precipitate obtain in the “coprecipitation process”. By adopting the “coprecipitation process”, a composite oxide having a crystal structure highly stable during lithium insertion/extraction reactions as an aimed final product is easily obtained and particularly a positive active material exhibiting a high battery performance can be prepared.

In the case that the “coprecipitation process” is adopted, for the purpose that the precursor mainly contains divalent Mn, first, it is important to maintain the reaction solution alkaline of pH 11 or higher. In this connection, when the pH of the reaction solution is too high, the formation rate of the precipitate is too high and the density of the precursor tends to decrease. From this viewpoint, the pH of the reaction solution is preferably 13 or lower, more preferably 12 or lower. Secondly, it is extremely important to maintain the reaction solution under a reductive atmosphere. Under the above conditions, the valency of Mn is maintained divalent and the precursor obtained by drying the precipitate formed becomes crystals mainly containing β-Ni(OH)₂ type structure. When the above conditions are not maintained, water and anion species such as carbonate anion are apt to be incorporated into the crystal structure and also the valency of Mn tends to increase, so that the precursor obtained by drying the precipitate formed contains a large number of α-Ni(OH)₂ type structure. As a method for maintaining the reaction solution under a reductive atmosphere, it is possible to make the inside of the reaction system a reductive atmosphere by introducing a reducing agent such as hydrazine into the reaction solution or filling the inside of the reaction vessel with an inert gas to remove oxygen.

In the “coprecipitation process”, the transition metal compound to be a raw material for the precursor is not particularly limited as long as it forms a precipitation reaction with an aqueous alkali solution but it is preferable to use a metal salt exhibiting a high solubility toward water. As the metal salts exhibiting a high solubility, there may be mentioned manganese oxide, manganese carbonate, manganese sulfate, manganese nitrate, and the like as Mn compounds, nickel hydroxide, nickel carbonate, nickel sulfate, nickel nitrate, and the like as Ni compounds, and cobalt sulfate, cobalt nitrate, and the like as Co compounds, for example.

Moreover, in the “coprecipitation process”, the presence of ammonium ion in the reaction solution is preferable. By the presence of the ammonium ion, the rate of the above precipitation reaction is lowered by effecting the reaction via a metal-amine complex formation reaction and hence the crystal orientation is enhanced and the composition becomes homogeneous, so that a precipitate having an even secondary particle form can be generated. Particularly, when nuclei for crystal growth are generated and grown under a condition that the amount of the ammonium ion in the reaction solution is made excessive to the amount of the metal ions derived from the raw materials such as Mn, Ni, and Co present in the reaction solution, an extremely homogeneous and bulky precipitate is formed and hence the case is preferable. As a method for making ammonium ion present, it may be mentioned to introduce ammonium sulfate, aqueous ammonia, and the like into the reaction solution. To the contrary, when ammonium ion is not present, the above metal ions rapidly form a precipitate through an acid-base reaction, so that the crystal orientation is disordered and a precipitate having an uneven particle shape and heterogeneous particle inner composition tends to form.

In this connection, among the reaction conditions relating to the “coprecipitation process”, by selecting apparatus factors such as shape of the reaction vessel and kind of rotation blades and various factors such as residential time of the precipitate in the reaction vessel, temperature of the reaction vessel, total ion content, and concentration of an oxidation number-regulating agent, it is also possible to slightly control physical properties such as the particle shape, bulk density, and surface area of the above coprecipitated compound.

Moreover, the above composite oxide may be one obtained by mixing a precursor mainly containing a compound having Mn and Ni as transition metals and having a β-Ni(OH)₂ type crystal structure, a Li compound and, if necessary, a precursor composed of a Co compound, followed by thermal treatment. In this case, the above precursor composed of a Co compound is preferably an oxide or a carbonate salt. There may be mentioned cobalt monoxide, cobalt oxyhydroxide, and tricobalt tetroxide as the oxides of Co, and basic cobalt carbonate as the carbonate salt of Co.

Furthermore, the precursor may be prepared by coating a cobalt compound exemplified below with Mn and Ni compounds. Namely, the precursor can be prepared by dropping a solution containing Mn and Ni into a suspension of a Co compound to thereby evenly deposit an Mn-Ni precipitate. The Co compound is not particularly limited as long as it has a low solubility. It is, however, preferred to use cobalt(II) oxide, cobalt(III) hydroxide oxide, dicobalt(III) monocobalt(II) tetroxide, cobalt(II) hydroxide, or the like. As mentioned above, it is necessary to fill the inside of the reaction system with a reductive atmosphere in order to restrain increase of valency of Mn. Moreover, the presence of ammonium ions is fundamentally necessary for evenly growing crystals on the Co compound. Under some conditions, however, ammonium ions need not be present because a Co compound is already present.

For the mixing of the precursor with the Li compound, a method of mixing individual powders mechanically can be employed. The mixing ratio [Li:(Mn+Ni+Co)] is necessarily a predetermined molar ratio according to an aimed composition but a slightly excess of the Li compound is preferable since an aimed stoichiometric composition can be obtained with compensating the loss of Li during sintering. When the atomic ratio [Li/(Mn+Ni+Co)] of the composite oxide after thermal treatment becomes less than 1.35, more preferably 1.2 or less, most preferably 1.10 or less and more than 0.95 as a result, a positive active material for lithium secondary batteries having a high energy density and a high charge/discharge cycle performance can be obtained. When the above ratio is 1.35 or more, an excess of Li compound accumulates on the surface of the active material and decrease in discharge capacity may probably occur. Moreover, when the above is 0.95 or less, change in structure occurs due to generation of oxygen deficit for compensating insufficient charges, so that migration of Li is inhibited and thus there is a possibility that battery performances may be remarkably deteriorated.

At the thermal treatment of the mixture of the precursor and the Li compound, the temperature for the above thermal treatment is preferably from 900° C. to 1050° C., more preferably from 950° C. to 1025° C. When the temperature for the thermal treatment is lower than 900° C., a problem of decrease in discharge capacity is apt to occur probably due to generation of a structural factor to inhibit the migration of Li. On the other hand, even when the temperature for the thermal treatment exceeds 1050° C., the synthesis is possible but when the temperature for the thermal treatment exceeds 1050° C., there are apt to occur a problem of densification of particles resulting in decrease in battery performance and a problem of difficulty in obtaining a composite oxide having an aimed composition owing to easy vaporization of Li during the thermal treatment. Furthermore, when the temperature for the thermal treatment exceeds 1050° C., atomic exchange occurs excessively between the above 6a sites and 6b sites in view of crystal structure, so that battery performance tends to decrease. Form the above viewpoint, the temperature for the thermal treatment in the range of 900° C. to 1050° C., preferably 950° C. to 1025° C., is preferred because it is possible to synthesize a positive active material for lithium secondary batteries having a high energy density and an excellent charge/discharge cycle performance.

The time for the thermal treatment is preferably from 3 hours to 50 hours. When the time for the thermal treatment exceeds 50 hours, Li is apt to vaporize during the thermal treatment and hence it is difficult to obtain a composite oxide having an aimed composition, so that substantially battery performance tends to be poor. On the other hand, when the time for the thermal treatment is less than 3 hours, there is a possibility that the development of crystals becomes poor and a result of inferior battery performance may be also obtained.

The atmosphere for the thermal treatment is preferably an atmosphere containing oxygen. In particular, in the thermal treatment process, at or after the stage of lowering the temperature which is a final stage of the process, oxygen atoms tend to be extracted from the crystal structure of the composite oxide formed and hence it is extremely preferable to use an atmosphere containing oxygen. As the atmosphere containing oxygen, air may be mentioned.

As a material for use as the negative electrode of the nonaqueous electrolyte battery according to the invention, there may be mentioned carbonaceous materials, metal oxides (tin oxides, silicon oxides, etc.) and materials modified by adding phosphorus or boron to these substances for the purpose of improving negative electrode characteristics. Of the carbonaceous materials, graphites have an operating potential very close to that of metallic lithium. Therefore, when a lithium salt is employed as an electrolyte salt, graphites are effective in diminishing self-discharge and in reducing the irreversible capacity in charge/discharge, so that graphites are hence preferable as negative-electrode materials. Analytical results by X-ray diffractometry and the like of graphites which can be suitably used are shown below.
Lattice spacing (d₀₀₂): 0.333-0.350 nm
Crystallite size in a-axis direction, La: 20 nm or more
Crystallite size in c-axis direction, Lc: 20 nm or more
True density: 2.00 to 2.25 g/cm³

It is also possible to modify a graphite by adding thereto a metal oxide such as tin oxide or silicon oxide, phosphorus, boron, amorphous carbon, or the like. In particular, modifying the surface of a graphite by the method described above is desirable because this modification can inhibit electrolyte decomposition and thereby heighten battery characteristics. Furthermore, a combination of a graphite with either lithium metal or a lithium metal-containing alloy such as lithium-aluminum, lithium-lead, lithium-tin, lithium-aluminum-tin, lithium-gallium, or Wood's alloy, or the like can be used as a negative electrode material. A graphite into which lithium has been inserted beforehand by electrochemical reduction can also be used as a negative active material.

The method or means for fabricating the nonaqueous electrolyte battery according to the invention is not particularly limited. For example, there may be used a method wherein a power generating element composed of a positive electrode, a negative electrode, and a separator is placed into a battery package composed of a facing body, then a liquid nonaqueous electrolyte is poured into the battery package, and finally the package is sealed. Alternatively, as in the case of a coin battery, there may be used a method wherein a positive electrode, a negative electrode, and a separator are independently housed in respective housing parts of a battery package having a positive electrode housing part, a negative electrode housing part, and a separator housing part, then a liquid nonaqueous electrolyte is poured into the battery package composed of a facing body, and finally the package is sealed.

The above positive electrode and negative electrode is preferably prepared using a conductive material and a binder as constituent components in addition to the above active material as the major constituent component.

The conductive material is not limited as long as it is an electron-conductive material not adversely influencing battery characteristics. Usually, however, conductive materials such as natural graphite (e.g., flake graphite, flaky graphite, or soil-like graphite), artificial graphite, carbon black, acetylene black, Ketjen Black, carbon whiskers, carbon fibers, metal powders (powders of copper, nickel, aluminum, silver, gold, etc.), metal fibers, and conductive ceramic materials can be incorporated alone or as a mixture thereof.

Of these, as the conductive material, acetylene black is desirable from the viewpoints of electron-conductive properties and applicability. The amount of the conductive material to be added is preferably from 1% by weight to 50% by weight, especially preferably from 2% by weight to 30% by weight, based on the total weight of the positive electrode or negative electrode. For mixing these ingredients, physical mixing is conducted. Homogeneous mixing is ideal. For this mixing, a powder mixer such as a V-type mixer, S-type mixer, mortar mill, ball mill, or planetary mill can be used in a dry or wet mixing process.

Incidentally, it is also possible to modify at least surface layer part of the powder of the positive active material and the powder of the negative active material with a conductive or ion conductive substance or a hydrophobic compound. For example, there may be mentioned a coating thereof with a good conductive substance such as gold, silver, carbon, nickel, or copper or a good ion conductive substance such as lithium carbonate, boron glass, a solid electrolyte, or a substance having a hydrophobic group, such as silicone oil by applying a technique such as plating, sintering, mechanofusion, vapor deposition, or baking.

The powder of the positive active material and the powder of the negative active material desirably have an average particle size of 100 μm or smaller. In particular, it is desirable that the average particle size of the powder of the positive active material be 10 μm or smaller for the purpose of improving the high-output characteristics of the nonaqueous electrolyte battery. A grinder and a classifier are used for obtaining a powder having a given shape. For example, there is used a mortar, ball mill, sand mill, oscillating ball mill, planetary ball mill, jet mill, counter jet mill, or cyclone type jet mill and sieves or the like. Grinding may be conducted by wet grinding in which water or an organic solvent such as hexane coexists. Methods of classification are not particularly limited, and sieves, an air classifier, or the like is used in each of dry and wet processes according to need.

As the binder, there can usually be used one of or a mixture of two or more of thermoplastic resins such as polytetrafluoroethylene, poly(vinylidene fluoride), polyethylene, and polypropylene, polymers having rubber elasticity, such as ethylene/propylene/diene terpolymers (EPDM), sulfonated EPDM, styrene/butadiene rubbers (SBR), and fluororubbers, polysaccharide such as carboxymethyl cellulose, and the like. Moreover, in the case that a binder having a functional group reactive with lithium, such as polysaccharide, it is, for example, desirable to deactivate the functional group by methylation or the like. The amount of the binder to be added is preferably from 1 to 50% by weight, especially preferably from 2 to 30% by weight, based on the total weight of the positive electrode or negative electrode.

The positive electrode and negative electrode are fabricated suitably by kneading a positive active material or a negative active material, a conductive material, and a binder with adding an organic solvent such as toluene or water, molding the kneaded product into an electrode shape, and drying the same.

In this connection, it is preferable to constitute a positive electrode so as to be closely attached to a current collector for the positive electrode and a negative electrode so as to be closely attached to a current collector for the negative electrode. For example, as the current collector, there can be used aluminum, titanium, stainless steel, nickel, sintered carbon, a conductive polymer, conductive glass, or the like. Besides these, there use can be used a material obtained by treating the surface of aluminum, copper, or the like with carbon, nickel, titanium, silver, or the like for the purpose of improving adhesiveness, conductivity, and oxidation resistance. As the current collector for the negative electrode, there can be used copper, nickel, iron, stainless steel, titanium, aluminum, sintered carbon, a conductive polymer, conductive glass, Al—Cd alloy, or the like. Besides these, there can be used a material obtained by treating the surface of copper or the like with carbon, nickel, titanium, silver, or the like for the purpose of improving adhesiveness, conductivity, and oxidation resistance. These materials can be subjected to a surface oxidation treatment.

With respect to the shape of the current collector, there may be used a foil form and also a film, sheet, net, punched or expanded, lath, porous, or foamed form, a structure made up of fibers, and the like. Although the thickness thereof is not particularly limited, collectors having a thickness of 1 to 500 μm are used. Of these current collectors, an aluminum foil excellent in oxidation resistance is preferable as the collector for the positive electrode and an inexpensive copper foil, nickel foil, and iron foil stable in reductive field and excellent in electrical conductivity, and an alloy foil containing part of these are preferably used as the current collector for the negative electrode. Furthermore, these foils preferably are ones having a surface roughness Ra of 0.2 μm or more. This surface roughness enables the current collector to be excellent in adhesiveness between the positive electrode or negative electrode and the current collector. Accordingly, it is preferred to use an electrolytic foil, which has such a rough surface. Most preferred is an electrolytic foil which has undergone a “hana” surface treatment.

The separator for non-aqueous electrolyte batteries preferably is one of or a combination of two or more of porous films, nonwoven fabrics, and the like which show excellent high-rate characteristics. Examples of the material constituting the separator for non-aqueous electrolyte batteries include polyolefin resins represented by polyethylene and polypropylene, polyester resins represented by poly(ethylene terephthalate) and poly(butylene terephthalate), poly(vinylidene fluoride), vinylidene fluoride/hexafluoropropylene copolymers, vinylidene fluoride/perfluorovinyl ether copolymers, vinylidene fluoride/tetrafluoroethylene copolymers, vinylidene fluoride/trifluoroethylene copolymers, vinylidene fluoride/fluoroethylene copolymers, vinylidene fluoride/hexafluoroacetone copolymers, vinylidene fluoride/ethylene copolymers, vinylidene fluoride/propylene copolymers, vinylidene fluoride/trifluoropropylene copolymers, vinylidene fluoride/tetrafluoroethylene/hexafluoropropylene copolymers, vinylidene fluoride/ethylene/tetrafluoroethylene copolymers, and the like.

The porosity of the separator for non-aqueous electrolyte batteries is preferably 98% by volume or lower from the viewpoint of strength. The porosity thereof is preferably 20% by volume or higher from the viewpoint of charge/discharge characteristics.

Moreover, as the separator for non-aqueous electrolyte batteries, there may be used a polymer gel constituted of a polymer of, e.g., acrylonitrile, ethylene oxide, propylene oxide, methyl methacrylate, vinyl acetate, vinylpyrrolidone, poly(vinylidene fluoride), or the like and an electrolyte.

Furthermore, a separator for non-aqueous electrolyte batteries which comprises a combination of a porous film, nonwoven fabric, or the like as described above and a polymer gel is desirable because use of this separator improves electrolyte retention. Namely, the surface of a microporous polyethylene film and the walls of the micropores are coated in a thickness of up to several micrometers with a polymer having affinity to solvents to form a coated film and then an electrolyte is caused to be held in the micropores of the coated film, whereby the polymer having affinity to solvents is converted to gel.

Examples of the polymer having affinity to solvents include poly(vinylidene fluoride) and polymers formed by crosslinking an acrylate monomer having an ethylene oxide group or ester group, epoxy monomer, monomer having isocyanate groups, or the like. At the crosslinking, heating, active ray such as ultraviolet ray (UV), or electron beams (EB), or the like can be used.

For the purpose of regulating strength or physical properties, a physical property regulator can be incorporated into the above polymer having affinity to solvents in such an amount as not to inhibit the formation of a crosslinked structure. Examples of the physical property regulator include inorganic fillers (metal oxides such as silicon oxide, titanium oxide, aluminum oxide, magnesium oxide, zirconium oxide, zinc oxide, and iron oxide and metal carbonates such as calcium carbonate and magnesium carbonate), polymers [poly(vinylidene fluoride), vinylidene fluoride/hexafluoropropylene copolymers, polyacrylonitrile, poly(methyl methacrylate), etc.] and the like. The amount of the physical property regulator to be added is generally 50% by weight or less, preferably 20% by weight or less, based on the crosslinkable monomer.

Examples of the above acrylate monomer include unsaturated monomers having a functionality of 2 or higher. Specific examples thereof include difunctional (meth)acrylates [ethylene glycol di(meth)acrylate, propylene glycol di(meth)acrylate, adipic acid dineopentyl glycol ester di(meth)acrylate, polyethylene glycol di(meth)acrylates having a degree of polymerization of 2 or higher, polypropylene glycol di(meth)acrylates having a degree of polymerization of 2 or higher, di(meth)acrylates of polyoxyethylene/polyoxypropylene copolymers, butanediol di(meth)acrylate, hexamethylene glycol di(meth)acrylate, and the like], trifunctional(meth)acrylates [trimethylolpropane tri(meth)acrylate, glycerol tri(meth)acrylate, tri(meth)acrylates of ethylene oxide adducts of glycerol, tri(meth)acrylates of propylene oxide adducts of glycerol, tri(meth)acrylates of ethylene oxide/propylene oxide adducts of glycerol, and the like}, and (meth)acrylates having a functionality of 4 or higher [pentaerythritol tetra(meth)acrylate, diglycerol hexa(meth)acrylate, and the like]. These monomers can be used solely or in combination.

A monofunctional monomer may be added to the above acrylate monomer for the purpose of physical property regulation, etc. Examples of the monofunctional monomer include unsaturated carboxylic acids [acrylic acid, methacrylic acid, crotonic acid, cinnamic acid, vinylbenzoic acid, maleic acid, fumaric acid, itaconic acid, citraconic acid, mesaconic acid, methylenemalonic acid, aconitic acid, and the like], unsaturated sulfonic acids [styrenesulfonic acid, acrylamido-2-methylpropanesulfonic acid, and the like], or salts of them (lithium salts, sodium salts, potassium salts, ammonium salts, tetraalkylammonium salts, and the like).

Moreover, there may be mentioned those obtained by partly esterifying unsaturated carboxylic acids with a C1-C18 aliphatic or alicyclic alcohol, alkylene (C2-C4) glycol, polyalkylene (C2-C4) glycol, or the like (methyl maleate, monohydroxyethyl maleate, and the like) or those obtained by partly amidating them with ammonia or a primary or secondary amine (maleic acid monoamide, N-methylmaleic acid monoamide, N,N-diethylmaleic acid monoamide, and the like); furthermore, (meth)acrylate esters [esters of (meth)acrylic acid with C1-C18 aliphatic (e.g., methyl, ethyl, propyl, butyl, 2-ethylhexyl, and stearyl) alcohols, and esters of (meth)acrylic acid with alkylene(C2-C4)glycols (ethylene glycol, propylene glycol, 1,4-butanediol, and the like) or with polyalkylene(C2-C4)glycols (polyethylene glycol and polypropylene glycol)], (meth)acrylamide or N-substituted (meth)acrylamides [(meth)acrylamide, N-methyl(meth)acrylamide, N-methylol(meth)acrylamide, and the like], vinyl esters or allyl esters [vinyl acetate, allyl acetate, and the like], vinyl ethers or allyl ethers [butyl vinyl ether, dodecyl allyl ether, and the like], unsaturated nitrile compounds [(meth)acrylonitrile, crotononitrile, and the like], unsaturated alcohols [(meth)allyl alcohol and the like], unsaturated amines [(meth)allylamine, dimethylaminoethyl (meth)acrylate, diethylaminoethyl (meth)acrylate, and the like]; heterocycle-containing monomers [N-vinylpyrrolidone, vinylpyridine, and the like], olefinic aliphatic hydrocarbons [ethylene, propylene, butylene, isobutylene, pentene, (C6-C50) α-olefins, and the like], olefinic alicyclic hydrocarbons [cyclopentene, cyclohexene, cycloheptene, norbornene, and the like], olefinic aromatic hydrocarbons [styrene, α-methylstyrene, stilbene, and the like], unsaturated imides [maleimide and the like], and halogen-containing monomers [vinyl chloride, vinylidene chloride, vinylidene fluoride, hexafluoropropylene, and the like].

Examples of the above epoxy monomer include glycidyl ethers [bisphenol A diglycidyl ether, bisphenol F diglycidyl ether, brominated bisphenol A diglycidyl ether, phenol-novolac glycidyl ether, cresol-novolac glycidyl ether, and the like], glycidyl esters [hexahydrophthalic acid glycidyl ester, dimer acid glycidyl esters, and the like], glycidylamines [triglycidyl isocyanurate, tetraglycidyldiaminophenyl-methane, and the like], linear aliphatic epoxides [epoxidized polybutadiene, epoxidized soybean oil, and the like], and alicyclic epoxides [3,4-epoxy-6-methylcyclohexylmethylcarboxylate, 3,4-epoxycyclohexyl-methylcarboxylate, and the like]. These epoxy resins can be used solely or after having been cured by addition of a curing agent thereto.

Examples of the curing agent include aliphatic polyamines [diethylenetriamine, triethylenetetramine, 3,9-(3-aminopropyl)-2,4,8,10-tetraoxaspiro[5,5]undecane, and the like}, aromatic polyamines [m-xylenediamine, diaminophenylmethane, and the like], polyamides [dimer acid polyamides and the like], acid anhydrides [phthalic anhydride, tetrahydromethylphthalic anhydride, hexahydrophthalic anhydride, trimellitic anhydride, and methylnadic anhydride], phenol compounds [phenol novolacs and the like], polymercaptans [polysulfides and the like], tertiary amines [tris(dimethylaminomethyl)phenol, 2-ethyl-4-methylimidazole, and the like], and Lewis acid complexes [boron trifluoride/ethylamine complex and the like].

Examples of the above monomer having isocyanate groups include toluene diisocyanate, diphenylmethane diisocyanate, 1,6-hexamethylene diisocyanate, 2,2,4(2,2,4)-trimethyl-hexamethylene diisocyanate, p-phenylene diisocyanate, 4,4′-dicyclohexylmethane diisocyanate, 3,3′-dimethyldiphenyl 4,4′-diisocyanate, dianisidine diisocyanate, m-xylene diisocyanate, trimethylxylene diisocyanate, isophorone diisocyanate, 1,5-naphthalene diisocyanate, trans-1,4-cyclohexyl diisocyanate, and lysine diisocyanate.

In crosslinking the monomer having isocyanate groups, a compound having active hydrogen may also be used, the compound including polyols and polyamines [difunctional compounds {water, ethylene glycol, propylene glycol, diethylene glycol, dipropylene glycol, and the like}, trifunctional compounds {glycerol, trimethylolpropane, 1,2,6-hexanetriol, triethanolamine, and the like}, tetrafunctional compounds {pentaerythritol, ethylenediamine, tolylenediamine, diphenylmethanediamine, tetramethylolcyclohexane, methylglucosides, and the like), pentafunctional compounds {2,2,6,6-tetrakis(hydroxylmethyl)cyclohexanol, diethylenetriamine, and the like}, hexafunctional compounds {sorbitol, mannitol, dulcitol, and the like}, and octafunctional compounds {sucrose and the like)], polyether polyols [propylene oxide and/or ethylene oxide adducts of the polyols or polyamines mentioned above], and polyester polyols [condensates of the aforementioned polyols with a polybasic acid (adipic acid, o-, m-, or p-phthalic acid, succinic acid, azelaic acid, sebacic acid, or ricinoleic acid}, polycaprolactone polyols {poly-ε-caprolactone and the like}, polycondensates of hydroxycarboxylic acids, and the like], and the like.

A catalyst may also be used in combination in conducting the crosslinking reaction. Examples of the catalyst include organotin compounds, trialkylphosphines, amines [monoamines {N,N-dimethylcyclohexylamine, triethylamine, and the like}, cyclic monoamines {pyridine, N-methylmorpholine, and the like}, diamines {N,N,N′,N′-tetramethylethylenediamine, N,N,N′,N′-tetramethyl-1,3-butanediamine, and the like}, triamines {N,N,N′,N′-pentamethyldiethylenetriamine and the like}, hexamines {N,N,N′,N′-tetra(3-dimethylaminopropyl)methanediamine and the like}, cyclic polyamines {diazabicyclooctane (DABCO), N,N′-dimethylpiperazine, 1,2-dimethylimidazole, 1,8-diazabicyclo(5,4,0)undecene-7 (DBU), and the like}, and salts of these.

The non-aqueous electrolyte battery according to the invention is fabricated preferably by injecting an electrolyte into a case, for example, before or after the stacking a separator for non-aqueous electrolyte batteries with a positive electrode and a negative electrode, and finally sealing the case with a facing body. In the case of a non-aqueous electrolyte battery employing a wound power generating element comprising a positive electrode and a negative electrode which have been stacked each other through a separator for non-aqueous electrolyte batteries, it is preferred that an electrolyte be injected into the power generating element before and after the winding. Although the infiltration may be conducted at ordinary pressure, the vacuum impregnation method or the pressure impregnation method can be used.

As the facing body, a thin material is preferred in view of lightening the nonaqueous electrolyte battery. For example, a metal/resin laminate film having a constitution comprising resin films and a metal foil sandwiched therebetween is preferred. Specific examples of the metal foil are not particularly limited as long as they are foils of aluminum, iron, nickel, copper, stainless steel, titanium, gold, silver, or the like which are free from pinholes, but lightweight and inexpensive aluminum foils are preferred. Preferred for use as the resin film to be disposed on the outer side in the battery is a resin film having an excellent piercing strength, such as a poly(ethylene terephthalate) film or nylon film. Preferred as the resin film to be disposed on the inner side in the battery is a film which is fusion-bondable and has solvent resistance, such as a polyethylene film or nylon film. Moreover, with respect to those for which long-term reliability, such as coating for power storage, are desired, those using a metallic battery can having higher sealing reliability are preferred.

### EXAMPLES

The following will describe the invention in detail, but the invention should not be construed as being limited to these descriptions.

<Synthesis of Composite Oxide “Positive Active Material A”>

First, a process for synthesizing a composite oxide used as a positive active material A in the present Example.

Into a closed type reaction vessel was introduced 3 L (liter) of water. Thereto was added 32% aqueous sodium hydroxide solution so as to result in a pH of 11.6. A stirrer having paddle type stirring blades was used to stir the solution at 1,200 rpm and the temperature of the solution in the reaction vessel was kept at 50° C. with a heater. Argon gas was bubbled into the solution in the reaction vessel to remove dissolved oxygen.

A raw-material solution was prepared at room temperature (20° C.). The raw-material solution to be used in the Example was obtained by mixing an aqueous manganese sulfate (MnSO₄) solution, an aqueous nickel sulfate (NiSO₄) solution, an aqueous cobalt sulfate (COSO₄) solution, and an aqueous hydrazine (NH₂NH₂) solution so as to result in a manganese concentration of 0.580 mol/L, a nickel concentration of 0.580 mol/L, cobalt concentration of 0.580 mol/L, and a hydrazine concentration of 0.0101 mol/L.

The above raw-material solution was continuously dropped into the reaction vessel at a flow rate of 3.2 ml/min with continuous stirring of the solution in the reaction vessel whose temperature was kept at 50° C. Simultaneously with this, 16 mol/L of aqueous ammonia was dropped into the above reaction vessel at a flow rate of 0.2 ml/min. A 32% aqueous sodium hydroxide solution was intermittently introduced into the reaction vessel so that the pH of the solution in the above reaction vessel was kept constant at 11.6(±0.05). Moreover, a flow pump was used to discharge a slurry from the system so that the liquid amount was always kept constant at 3.0 L. After 60 hours had passed since the start of the dropping of the raw-material solution and before 5 hours passed thereafter, a slurry of a coprecipitation product was taken out. The slurry taken out was washed with water, filtered, and dried at 100° C. overnight to obtain a powder of an Ni—Mn—Co coprecipitated precursor. As a result of measurement by X-ray diffractometry, the Ni—Mn—Co coprecipitated precursor was found to contain mainly a β-Ni(OH)₂ type crystal structure.

The Ni—Mn—Co coprecipitated precursor obtained and lithium hydroxide monohydrate powder were weighed out so that Li/(Ni+Mn+Co)=1.0, followed by thorough mixing. This mixture was charged into a pot made of alumina. Using an electric furnace, the mixture was, in a dry air stream, heated to 1000° C. at a heating rate of 100° C./hr, held at the temperature of 1000° C. for 15 hours, subsequently cooled to 600° C. at a cooling rate of 100° C./hr, and then allowed to cool to obtain a Li—Mn—Ni—Co composite oxide. As a result of measurement by X-ray diffractometry, the Li—Mn—Ni—Co composite oxide obtained was found to contain mainly an α-NaFeO₂ structure belonging to the space group R3-m. As a result of ICP compositional analysis, the composition was ascertained to be LiMn_{0.33}Ni_{0.33}Co_{0.33}O₂. The Li—Mn—Ni—Co composite oxide was referred to as “positive active material A”.

<Synthesis of Composite Oxide “Positive Active Material B”>

A Li—Mn—Ni—Co composite oxide was obtained in the same manner as described above except that a solution obtained by mixing an aqueous manganese sulfate (MnSO₄) solution, an aqueous nickel sulfate (NiSO₄) solution, an aqueous cobalt sulfate (COSO₄) solution, and an aqueous hydrazine (NH₂NH₂) solution so as to result in a manganese concentration of 0.281 mol/L, a nickel concentration of 0.281 mol/L, cobalt concentration of 1.179 mol/L, and a hydrazine concentration of 0.0101 mol/L. As a result of measurement by X-ray diffractometry, the Li—Mn—Ni—Co composite oxide obtained was found to contain mainly an α-NaFeO₂ structure belonging to the space group R3-m. As a result of ICP compositional analysis, the composition was ascertained to be LiMn_{0.16}Ni_{0.16}Co_{0.67}O₂. The Li—Mn—Ni—Co composite oxide was referred to as “positive active material B”.

<Synthesis of Composite Oxide “Positive Active Material C”>

A Li—Mn—Ni—Co composite oxide was obtained in the same manner as described above except that a solution obtained by mixing an aqueous manganese sulfate (MnSO₄) solution, an aqueous nickel sulfate (NiSO₄) solution, an aqueous cobalt sulfate (CoSO₄) solution, and an aqueous hydrazine (NH₂NH₂) solution so as to result in a manganese concentration of 0.141 mol/L, a nickel concentration of 0.141 mol/L, cobalt concentration of 1.478 mol/L, and a hydrazine concentration of 0.0101 mol/L. As a result of measurement by X-ray diffractometry, the Li—Mn—Ni—Co composite oxide obtained was found to contain mainly an α-NaFeO₂ structure belonging to the space group R3-m. As a result of ICP compositional analysis, the composition was ascertained to be LiMn_{0.08}Ni_{0.08}Co_{0.84}O₂. The Li—Mn—Ni—Co composite oxide was referred to as “positive active material C”.

(Nonaqueous Electrolyte Battery>

FIG. 1 is a sectional view of the nonaqueous electrolyte battery according to the Example. The nonaqueous electrolyte battery according to the Example is constituted by an electrode group 4 composed of a positive electrode 1 wherein a positive composite 11 is placed on a positive collector 12, a negative electrode 2 wherein a negative composite 21 is placed on a negative collector 22, and a separator 3, a nonaqueous electrolyte, and a metal/resin laminate film 5 as a facing body. The nonaqueous electrolyte is impregnated into the above electrode group 4. The metal/resin laminate film 5 covers the electrode group 4 and four corners thereof were sealed by heat fusion-bonding.

<Production of Nonaqueous Electrolyte Batteries (cf. FIG. 1 Described Above)>

The following will describe a process for fabricating nonaqueous electrolyte batteries having the above constitution.

As the positive electrode 1, a positive active material and acetylene black as a conductive material were mixed and further an N-methyl-2-pyrrolidone solution of poly(vinylidene fluoride) as a binder was mixed therewith. After the mixture was applied on one surface of the positive collector 12 made of aluminum foil, the whole was dried and pressed. By the above steps, the positive electrode 1 wherein the positive composite 11 was placed on the positive collector 12 was obtained. In this connection, the thickness of the positive composite may suitably increase or decrease depending on the designed capacity of the battery.

As the negative electrode 2, a graphite as a negative active material and an N-methyl-2-pyrrolidone solution of poly(vinylidene fluoride) as a binder were mixed. After the mixture was applied on one surface of the negative collector 22 made of copper foil, the whole was dried and pressed. By the above steps, the negative electrode 2 wherein the negative composite 21 was placed on the negative collector 22 was obtained. In this connection, the thickness of the negative composite 21 may suitably increase or decrease depending on the designed capacity of the battery.

As the separator 3, a polyethylene microporpus film (average pore size: 0.1 μm, rate of hole area: 50%, thickness: 23 μm, weight: 12.52 g/m², air permeability: 89 second/100 mL), a porous substrate, was used. The electrode group 4 was constituted by facing the above positive composite 11 and the above negative composite 21, placing the separator 3 between them, and laminating the whole. The nonaqueous electrolyte was obtained by dissolving 1 mol of LiPF₆ into 1 L of a mixed solvent in which ethylene carbonate and diethyl carbonate were mixed in a volume ratio of 5:5 and further mixing vinylene carbonate in an amount of 2% by weight.

Then, by dipping the electrode group 4 in the nonaqueous electrolyte, the nonaqueous electrolyte was impregnated into the electrode group 4. The electrode group 4 was covered with the metal/resin laminate film 5 and four corners thereof were sealed by heat fusion-bonding.

By the above process, nonaqueous electrolyte batteries according to the present Example were fabricated.

(Inventive Battery 1)

Using the above positive active material A whose composition was ascertained to be LiMn_{0.33}Ni_{0.33}Co_{0.33}O₂ as a positive active material, a nonaqueous electrolyte battery having nominal capacity of 600 mAh was fabricated by the above procedure. This battery was referred to as “inventive battery 1”.

(Inventive Battery 2)

Using the above positive active material B whose composition was ascertained to be LiMn_{0.16}Ni_{0.16}Co_{0.67}O₂ as a positive active material, a nonaqueous electrolyte battery having nominal capacity of 600 mAh was fabricated by the above procedure. This battery was referred to as “inventive battery 2”.

(Inventive Battery 3)

Using the above positive active material C whose composition was ascertained to be LiMn_{0.08}Ni_{0.08}Co_{0.84}O₂ as a positive active material, a nonaqueous electrolyte battery having nominal capacity of 600 mAh was fabricated by the above procedure. This battery was referred to as “inventive battery 3”.

(Inventive Battery 4)

A nonaqueous electrolyte battery having nominal capacity of 600 mAh was fabricated in the same manner as in the case of the inventive battery 2 except that a solution obtained by dissolving, in a concentration of 1 mol/L, a mixed lithium salt of LiPF₆ and LiN(CF₃SO₂)₂ in a weight ratio of 95:5 into 1 L of a mixed solvent in which ethylene carbonate and diethyl carbonate were mixed in a volume ratio of 5:5 and further mixing vinylene carbonate in an amount of 2% by weight was used as a nonaqueous electrolyte. This battery was referred to as “inventive battery 4”.

(Inventive Battery 5)

A nonaqueous electrolyte was obtained by dissolving 1 mol of LiPF₆ into 1 L of a mixed solvent containing ethylene carbonate, dimethyl carbonate, and ethyl methyl carbonate in a volume ratio of 6:7:7 and further mixing vinylene carbonate in an amount of 1% by weight and 1,3-propanesultone in an amount of 1% by weight. A nonaqueous electrolyte battery having nominal capacity of 600 mAh was fabricated in the same manner as in the case of the inventive battery 2 except that the above nonaqueous electrolyte was used as a nonaqueous electrolyte. This battery was referred to as “inventive battery 5”.

(Comparative Battery 1)

Using LiMn₂O₄ having a spinel type crystal structure as a positive active material, a nonaqueous electrolyte battery having nominal capacity of 600 mAh was fabricated in the same manner as in the case of the inventive battery 1. This battery was referred to as “Comparative battery 1”.

(Comparative Battery 2)

Using LiCoO₂ as a positive active material, a nonaqueous electrolyte battery having nominal capacity of 600 mAh was fabricated in the same manner as in the case of the inventive battery 1. This battery was referred to as “Comparative battery 2”.

(Comparative Battery 3)

A nonaqueous electrolyte battery having nominal capacity of 600 mAh was fabricated in the same manner as in the case of the inventive battery 1 except that a solution obtained by dissolving 1 mol of LiPF₆ into 1 L of a mixed solvent in which ethylene carbonate and diethyl carbonate were mixed in a volume ratio of 5:5 was used as a nonaqueous electrolyte and vinylene carbonate was not mixed. This battery was referred to as “Comparative battery 3”.

(High-Temperature Storage Test)

On each of the inventive batteries 1 to 3 and comparative batteries 1 to 3, three cycles of initial charge/discharge were conducted at a temperature of 25° C. The charge was constant-current constant-voltage charge conducted under the conditions of a current of 600 mA and a terminal voltage of 4.2 V, while the discharge was constant-current discharge conducted under the conditions of a current of 600 mA (1.0 It) and a terminal voltage of 3.0 V. The discharge capacity obtained at the third cycle was referred to as “1.0It initial discharge capacity (mAh)”.

Subsequently, discharge using a discharge rate of various discharge rates was conducted at a temperature of 25° C. Every charge was constant-current constant-voltage charge conducted under the conditions of a current of 600 mA and a terminal voltage of 4.2 V, while the discharge was constant-current discharge conducted under the conditions of a current of 120 mA (0.2 It), 600 mA (1.0 It), or 1200 mA (2.0 It) and a terminal voltage of 3.0 V. The discharge capacity obtained under a current of 120 mA (0.2 It) was referred to as “0.2It initial discharge capacity (mAh)”. Furthermore, the discharge capacity obtained under a current of 1200 mA (2 It) was referred to as “2It initial discharge capacity (mAh)”.

Then, each battery was charged at constant-current constant-voltage under the conditions of a current of 600 mA and a terminal voltage of 4.2 V at a temperature of 25° C. to achieve an end-of-charge state and then battery thickness was measured. The thickness was referred to as “battery thickness before storage (mm)”.

Thereafter, all the batteries were transferred into a constant-temperature bath at 50° C. and initial storage was started. On the 14th day from the start of the storage, the batteries were taken out and battery thickness was measured after battery temperature was returned to 25° C. The battery thickness at that time was referred to as “battery thickness on 14th day (mm)”.

Then, all the batteries were returned again into the constant-temperature bath at 50° C. and the storage was continued. On the 30th day from the start of the initial storage, the batteries were again taken out and battery thickness was measured after battery temperature was returned to 25° C. The battery thickness at that time was referred to as “battery thickness on 30th day (mm)”.

Subsequently, each battery was subjected to constant-current discharge conducted under the conditions of a current of 120 mA (0.2 It) and a terminal voltage of 3.0 V at a temperature of 25° C., followed by 4 cycles of charge/discharge. The charge was constant-current constant-voltage charge conducted under the conditions of a current of 600 mA and a terminal voltage of 4.2 V, while the discharge was constant-current discharge conducted under the conditions of a current of 600 mA (1.0 It) and a terminal voltage of 3.0 V. The percentage of the discharge capacity at the 4th cycle in this case to the above “1.0It initial discharge capacity (mAh)” is calculate and referred to as “1.0It recovered capacity retention ratio (%)”.

Subsequently, after each battery was again subjected to constant-current constant-voltage charge conducted under the conditions of a current of 600 mA and a terminal voltage of 4.2 V similarly at the temperature of 25° C., it was subjected to constant-current discharge conducted under the conditions of a current of 120 mA (0.2 It) and a terminal voltage of 3.0 V. The percentage of the discharge capacity in this case to the above “0.2It initial discharge capacity (mAh)” is calculated and referred to as “0.2It recovered capacity retention ratio (%)”.

Then, all the batteries were returned again into the constant-temperature bath at 50° C. and the storage was continued. On the 56th day and 84th day from the start of the initial storage, the batteries were taken out and battery thickness was measured after battery temperature was returned to 25° C. The battery thickness on the 56th day and the battery thickness on the 84th day were referred to as “battery thickness on 56th day (mm)” and “battery thickness on 84th day (mm)”, respectively. The percentage of an increase ratio of the “battery thickness on 84th day” to the above “battery thickness before storage” is calculated and referred to as “increase ratio of battery thickness (%)”.

In this connection, for the measurement of the above battery thickness, a dial micrometer (manufactured by Mitsutoyo, Model number: 289-511N, Probe shape: cylindrical, Probe diameter: 6.3 mm) was used.

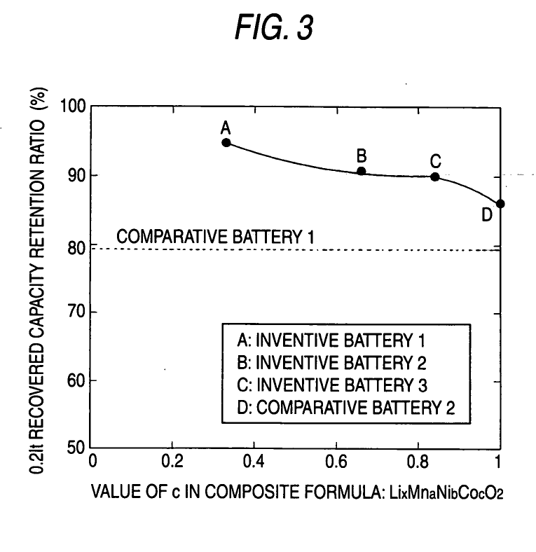

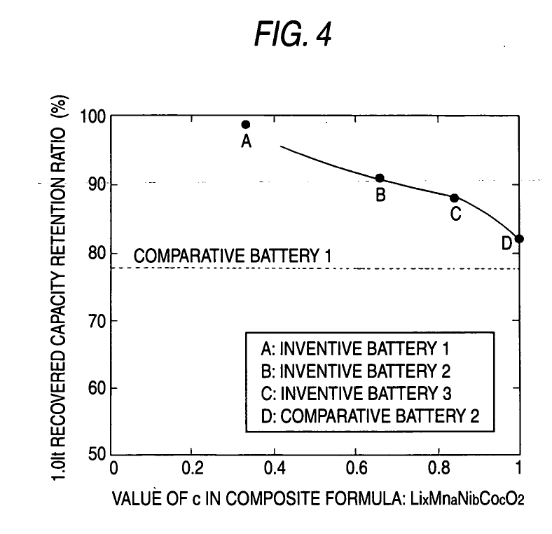

The results in the above are shown in Table 1 and FIGS. 2 to 4. In Table 1, change in battery thickness with days of high-temperature storage was shown on all the inventive batteries and comparative batteries. In FIG. 2, the increase ratio of the battery thickness by 84-days high-temperature storage was shown in relation to the c value in the composite formula: LiₓMnₐNi_{b}Co_{c}O₂ on the inventive batteries 1 to 3 and the comparative battery 2 using a nonaqueous electrolyte containing a cyclic carbonate having a carbon-carbon π bond and using a composite oxide having an α-NaFeO₂ type crystal structure as a positive active material. In FIGS. 3 and 4, the value of 0.2It recovered capacity retention ratio and the value of 1.0It recovered capacity retention ratio were respectively shown in relation to the c value in the composite formula: LiₓMnₐNi_{b}Co_{c}O₂ on the inventive batteries 1 to 3 and the comparative battery 2 using a nonaqueous electrolyte containing a cyclic carbonate having a carbon-carbon π bond and using a composite oxide having an α-NaFeO₂ type crystal structure as a positive active material. In this connection, in FIGS. 3 and 4, the value of Comparative Example 1 using LiMn₂O₄ having a spinel type crystal structure as a positive active material was also shown by a dotted line for the purpose of comparison.

TABLE 1

| | Battery | | | | |
|---|---|---|---|---|---|
| | thickness | Battery | Battery | Battery | Battery |
| | before | thickness on | thickness on | thickness on | thickness on |
| | storage (mm) | 14th day (mm) | 30th day (mm) | 56th day (mm) | 84th day (mm) |
| Inventive | 3.2 | 3.3 | 3.3 | 3.3 | 3.4 |
| battery 1 | | | | | |
| Inventive | 3.2 | 3.2 | 3.3 | 3.3 | 3.5 |
| battery 2 | | | | | |
| Inventive | 3.3 | 3.3 | 3.4 | 3.4 | 3.5 |
| battery 3 | | | | | |
| Comparative | 4.0 | 4.0 | 4.1 | 4.2 | 4.4 |
| battery 1 | | | | | |
| Comparative | 3.5 | 3.5 | 3.6 | 3.7 | 4.1 |
| battery 2 | | | | | |
| Comparative | 3.5 | 3.5 | 3.6 | 3.8 | 4.2 |
| battery 3 | | | | | |

As shown in Table 1, the battery thickness before storage of the comparative battery 1 is about 4 mm, which is thick when compared with the fact that the thickness of the other batteries ranges from about 3.2 to 3.4 mm. This is because the positive composite 11 is thickly placed so as to adjust nominal capacity of the battery to 600 mAh since theoretical energy density of LiMn₂O₄ having a spinel type crystal structure used as a positive active material is low. Thus, since use of only a composite oxide having a spinel type crystal structure as a positive active material is not preferred because of a low volume energy density of the battery, it is required for a positive electrode to contain a positive active material composed of a composite oxide having an α-NaFeO₂-type crystal structure.

As is apparent from the results of Table 1, when the inventive battery 1 and the comparative battery 3 using the same kind of positive active material are compared, the increase ratio of the battery thickness was extremely large in the comparative battery 3 using a nonaqueous electrolyte containing no cyclic carbonate having a carbon-carbon π bond. This may be attributable to gas generation through decomposition of the solvent used in the nonaqueous electrolyte on the negative electrode. On the other hand, in the inventive batteries, there was confirmed an effect of restraining swelling of the batteries during high-temperature storage by incorporating vinylene carbonate as the cyclic carbonate having a carbon-carbon π bond into the nonaqueous electrolyte.

Moreover, as is apparent from FIG. 2, as compared with the increase ratio of the battery thickness of about 16% in the comparative battery 2 using, as a positive active material, LiCoO₂ having an α-NaFeO₂-type crystal structure and corresponding to the compound wherein c is 1 in the composite formula: LiₓMnₐNi_{b}Co_{c}O₂, the increase ratio of the battery thickness is about 5% to 8% in the inventive batteries 1 to 3 using, as a positive active material, a composite oxide which also has an α-NaFeO₂ type crystal structure and wherein c is less than 1 and |a-b| is less than 0.05 in the above composite formula, the result clearly showing that swelling of the batteries are remarkably restrained. Accordingly, it is revealed that the effect of restraining swelling of batteries during high-temperature storage is largely influenced by not only the presence of the cyclic carbonate having a carbon-carbon π bond in the nonaqueous electrolyte but also the kind of the positive active material. In particular, it is revealed that the effect of restraining swelling of batteries during high-temperature storage is extremely remarkably exhibited by selecting a composite oxide wherein c is less than 1 and |a-b| is less than 0.05 from among the lithium transition metal composite oxides having an α-NaFeO₂-type crystal structure and represented by the composite formula: LiₓMnₐNi_{b}Co_{c}O₂.

Next, as is apparent from FIGS. 3 and 4 in which the recovered capacity retention ratios after high-temperature storage test are compared, among the batteries using a nonaqueous electrolyte containing a cyclic carbonate having a carbon-carbon π bond, the inventive batteries 1 to 3 and the comparative battery 2 using a composite oxide having an α-NaFeO₂-type crystal structure as a positive active material show an extremely good high-temperature storage-resistant performance as compared with the comparative battery 1 using a composite oxide having a spinel type crystal structure as a positive active material. Furthermore, it is revealed that, among the inventive batteries 1 to 3 and the comparative battery 2 using the same composite oxide having an α-NaFeO₂-type crystal structure as a positive active material, the inventive batteries 1 to 3 wherein c is less than 1 in the composite formula: LiₓMnₐNi_{b}Co_{c}O₂ show remarkably excellent high-temperature storage-resistant performance in high-temperature storage-resistant performance as compared with the comparative battery 2 wherein c is 1.

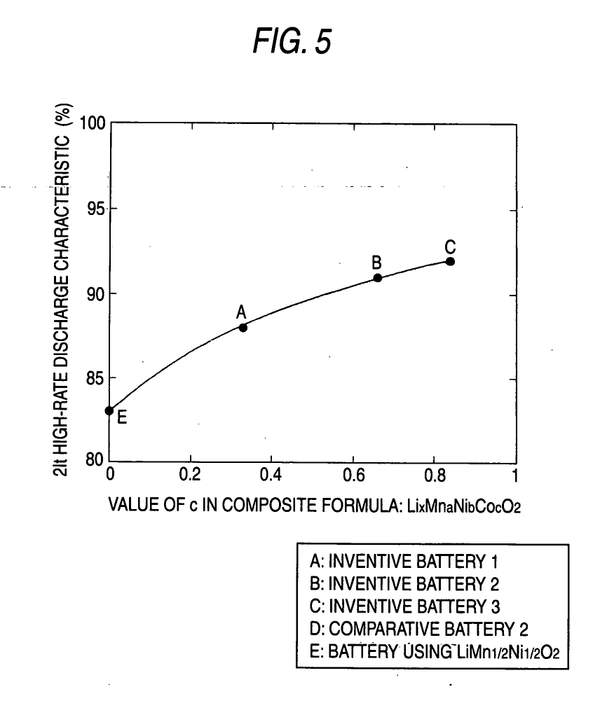

Incidentally, the inventive batteries 1 to 3 additionally fabricated and a battery fabricated in the same manner as in Example 1 using a composite oxide having an α-NaFeO₂-type crystal structure and represented by the composite formula: LiMn_{1/2}Ni_{1/2}O₂ as a positive active material were prepared and the 2It initial discharge capacity was determined in the same manner as in the above battery test. The results are shown in FIG. 5. For the results, the case where c is 0 in the composite formula: LiₓMnₐNi_{b}Co_{c}O₂, the 2It high-rate discharge capacity decreases to 85% or lower and the case is not practical. It is presumed that this result may be relevant to the fact that synthesis of the composite oxide having a homogeneous crystal structure is difficult in the case where c is 0.

From the above, it is necessary to have an α-NaFeO₂-type crystal structure and satisfy the requirement of 0<c<1 in the composite formula: LiₓMnₐNi_{b}Co_{c}O₂. Particularly, it is preferred to satisfy the requirement of 0.33≦c≦0.8.

Also on the inventive batteries 4 and 5, the effects of the invention were confirmed as on the inventive batteries 1 to 3. Furthermore, in the inventive battery 4, the increase ratio of the battery thickness was 3%. Therefore, it was confirmed that the inventive battery 4 has an improved high-temperature storage-resistant performance as compared with the comparative battery 2 using the same positive active material. Moreover, the inventive battery 5 was located at a slightly higher position as compared with “B: Inventive battery 2” shown in FIGS. 3 to 5 and thus it was confirmed that the inventive battery 5 was slightly improved as compared with the inventive battery 2.

In the above Examples, there were described the examples wherein vinylene carbonate was used as a cyclic carbonate having a carbon-carbon π bond. The same effects were, however, confirmed in the case that styrene carbonate, catechol carbonate, vinylethylene carbonate, 1-phenylvinylene carbonate, or 1,2-diphenylvinylene carbonate was used instead of the above vinylene carbonate.

Moreover, in the above Examples, there were described the examples wherein a composite oxide containing no different element M was used as a positive active material but the same effects were confirmed in the case that a composite oxide wherein M in the composite formula: LiₓMnₐNi_{b}Co_{c}M_{d}O₂ is selected from any of V, Al, Mg, Cr, Ti, Cu, and Zn and d is in the range of 0.1 or less is used as a positive active material.

Furthermore, since the nonaqueous electrolyte battery of the invention is excellent in storage performance under a high-temperature environment, it is easy to apply and develop to large-scale large-capacity batteries for power storage and for use in electric motorcars.

The invention can be carried out in other various forms without departing from the spirit or main characteristics thereof. Therefore, the above embodiments or Examples are only mere illustrations and they should not be construed in a limited way. The scope of the invention is defined only by claims and is not restricted to the content of the Description. Furthermore, any changes and modifications belonging to an equivalent range of claims are all within the scope of the invention.

### INDUSTRIAL APPLICABILITY

As described in the above, according to the invention, a nonaqueous electrolyte battery which restrains swelling of battery during high-temperature storage and is excellent in battery characteristics after storage can be provided.

1. A nonaqueous electrolyte battery comprising a positive electrode, a negative electrode, and a nonaqueous electrolyte, wherein the above nonaqueous electrolyte contains at least a cyclic carbonate having a carbon-carbon 7r bond and the above positive electrode contains a positive active material comprising a composite oxide represented by a composite formula: LiₓMnₐNi_{b}CO_{c}O₂ (wherein 0≦x≦1, a+b+c=1, |a-b|<0.05, 0<c<1) and having an α-NaFeO₂-type crystal

2. A nonaqueous electrolyte battery comprising a positive electrode, a negative electrode, and a nonaqueous electrolyte, wherein the above positive electrode contains a positive active material comprising a composite oxide represented by a composite formula: LiₓMnₐNi_{b}CO_{c}O₂ (wherein 0≦x≦1, a+b+c=1, |a-b|<0.05, 0<c<1) and having an α-NaFeO₂-type crystal structural and the battery is fabricated using a nonaqueous electrolyte containing at least a cyclic carbonate having a carbon-carbon π bond.

3. The nonaqueous electrolyte battery according to claim 1 wherein the above cyclic carbonate having a carbon-carbon π bond is one or more selected from the group consisting of vinylene carbonate, styrene carbonate, catechol carbonate, vinylethylene carbonate, 1-phenylvinylene carbonate, and 1,2-diphenylvinylene carbonate.

4. The nonaqueous electrolyte battery according to claim 1, wherein the above negative electrode contains a graphite.

5. The nonaqueous electrolyte battery according to claim 1, wherein the above nonaqueous electrolyte uses a mixture of an inorganic lithium salt and an organic lithium salt having a perfluoroalkyl group.

6. The nonaqueous electrolyte battery according to claim 2, wherein the above cyclic carbonate having a carbon-carbon π bond is one or more selected from the group consisting of vinylene carbonate, styrene carbonate, catechol carbonate, vinylethylene carbonate, 1-phenylvinylene carbonate, and 1,2-diphenylvinylene carbonate.

7. The nonaqueous electrolyte battery according to claim 2, wherein the above negative electrode contains a graphite.

8. The nonaqueous electrolyte battery according to claim 2, wherein the above nonaqueous electrolyte uses a mixture of an inorganic lithium salt and an organic lithium salt having a perfluoroalkyl group.
